(19) United States
(12) Patent Application Publication
(10) Pub. No.: US 2022/0104428 A1
(43) Pub. Date: Apr. 7, 2022

(54) SUGAR BEET DEFOLIATOR AND TOP SAVER

(71) Applicant: Robert William Guccion, Lovell, WY (US)

(72) Inventor: Robert William Guccion, Lovell, WY (US)

(21) Appl. No.: 17/063,922

(22) Filed: Oct. 6, 2020

(51) Int. Cl. A01D 23/06; A01D 23/02; A01D 69/03

(52) U.S. Cl. CPC A01D 23/06; A01D 23/02; A01D 2023/024; A01D 2023/022; A01D 69/03

(57) ABSTRACT

A sugar beet defoliator and top saver having a frame, removable cover, conveyor extending laterally across the frame, steel flails disposed about a first rotating shaft situated between a front end of the frame and the conveyor, rubber flails disposed about a second rotating shaft situated within the frame rearward of the conveyor, ground wheels situated rearward of the frame, and scalper blades arranged transversely relative to the frame and situated rearwardly of the ground wheels. An interior shroud is situated between the steel flails and a front end of the frame, and a crank arm is configured to move a deflector plate from a first position to a second position. When the deflector plate is in the first position, it extends horizontally parallel with a top end of the shroud. When the deflector plate is in the second position, it is situated between the steel flails and the conveyor.

### BACKGROUND OF THE INVENTION

### 1. Field of the Invention

The present invention is in the field of agricultural equipment, and more particularly, a single piece of equipment that both defoliates sugar beets and saves the sugar beet tops.

### 2. Description of the Related Art

The present invention offers four distinct but related advantages over current technology for defoliating and top saving sugar beets. First, the present invention is able to both defoliate sugar beets (leaving the defoliated vegetation between the rows for decomposition and green manure) and save the sugar beet tops in a windrow to the side of the beet roots to be harvested and later used for livestock feed. Until the present invention, there was no single machine that could accomplish both of these tasks. As a result, capital acquisition and maintenance costs are decreased, as are labor costs associated with running the equipment.

Second, the present invention creates a higher quality livestock feed that is free of excessive dirt in the topped windrow to be later utilized by livestock. Third, the present invention is designed to save the beet tops without excessive root yield loss due to the dislodging of harvestable beet roots or excessive crowning. Fourth, the present invention leaves the beet root ready to be harvested with one operator, one pass, and only one machine. Although there have been innovations in both beet defoliators and top savers, there is nothing in the prior art that combines both of these functions in the same piece of equipment.

U.S. Pat. No. 1,258,456 (Pulver et al., 1918) is one of the first examples of prior art in this area. This patent covers a beet topping machine with two ground wheels, two trailer wheels, fenders or gathering members, a vertical cutting disc, and a plurality of horizontally disposed cutting members. Each fender has a forward end with a bent portion that forms a substantially horizontal flange. The leafy tops that have been severed from the beet roots are thrown to the side. The topper frame swings laterally by means of foot levers controlled by the operator. The machine is operated by draught animals or by mechanical power such as a tractor.

U.S. Pat. No. 2,314,681 (Beatty, 1942) describes a beet topper and digger comprised of a pair of vertically adjustable, spaced-apart, foliage-lifting members, a link member hinged to each foliage-lifting member and extending rearwardly therefrom, and a beet-engaging runner hinged to the rear extremity of each link member. The runners are configured to rise and fall in accordance with the height of the beets in the ground. Co-acting topping knives are carried by the runners and positioned to top the beets passing between them.

U.S. Pat. No. 2,358,400 (Kiest, 1942) is another example of a beet topper and digger. This invention comprises an upwardly inclined conveyor and vertically adjustable digging elements, each of which is comprised of a cylindrical shank with terminal shoes. The beet topping mechanism is comprised of a belt-shaped member with a beet-topping knife. A substantially V-shaped pressure shoe depends from the frame in front of the bell-shaped member and comprises pivotally connected plates with springs between them. The beet tops are thrown laterally in windrows by the revolving bell-shaped member.

U.S. Pat. No. 2,478,877 (Smith, 1949) provides a beet harvester with lifting plows that dig up topped beets and deposit them onto an elevating conveyor belt, which carries them to a receiving hopper. The receiving hopper dumps the topped beets at desired intervals into a receiving truck. The topping mechanism comprises an inverted, U-shaped floating frame and a curved topping knife extending across the bottom of the floating frame. Feeler frames are hingedly attached to the front of each side of the floating frame.

U.S. Pat. No. 2,505,089 (Bailey et al., 1950) discloses a beet topper with two pairs of discs, a plurality of spaced supporting rods, and a plurality of topping or stripping bars spaced apart from one another by spacing blocks. In order to remove the topped foliage, a separate blower must be used.

U.S. Pat. No. 2,587,258 (Wilkinson, 1952) shows a beet cleaning apparatus comprised of a wheeled supporting frame, a horizontal elongated rotatable beater unit mounted on the frame, and bracket means rotatably supporting the beater unit. The beater unit includes a multiplicity of axially spaced flexible flail elements extending radially from the axis of the beater unit. The beater unit and bracket means are movable up and down about a pivot means. A locator shoe connected to the bracket means extends ahead of and adjacent to the lower edge of the beater unit.

U.S. Pat. No. 2,759,318 (Oppel, 1956), titled “Beater Type Topping Machine,” describes a machine that can be used to remove the tops of sugar beets, potatoes, and the like. The machines comprises a multiplicity of beater elements or flails mounted on a shaft. The machine comprises a tongue for connection to a towing vehicle and a hood that is pivotally connected to the tongue. The hood may be raised and lowered to adjust it to the proper height for operation of the beater.

U.S. Pat. No. 3,031,833 (Nelson, 1962) covers a beat topping machine that functions as a top saver but not a defoliator. This machine is comprised of a cutting mechanism with a rectangularly shaped reinforcing frame and an elongate shaft. A plurality of cutting elements are arranged along the entire length of the sleeve positioned around the shaft. The cutting elements are formed of rigid metallic material. Each cutting element has one end that is acutely bent into a U-shaped configuration and another end that is provided with a replaceable cutting tip. The invention further comprises an auger conveyor situated within a frame. A trimming mechanism is positioned rearwardly of the cutting mechanism and the conveyor mechanism.

U.S. Pat. No. 3,306,017 (Wells, 1067) provides an apparatus for topping sugar beets and saving the severed tops. The invention comprises a mobile frame, a cutter disc positioned on the frame for topping beets, a cutter drive means, and a stationary deflector means extending across the upper surface of the cutter disc and positioned to guide the tops rearwardly over and from the upper surface of the cutter disc. The invention further comprises a top pickup means that is rotatably carried by the frame rearwardly of the cutter disc and configured to lift and transfer the tops from the cutter disc rearwardly in a continuous flow above the ground surface.

U.S. Pat. No. 3,435,900 (Weichel, 1969) illustrates a self-loading wagon for harvesting sugar beets. The invention is a self-loading truck with a loading chamber, means for severing the head portions of sugar beets, a first conveyor means for transporting the beet tops to the first compartment, a plurality of means for uprooting the root portions, and a second conveyor means for transporting the root portions to the second compartment. Secondary conveyors transport the material to the rear of each compartment.

U.S. Pat. No. 3,583,136 (Eisenhardt, 1971) discloses a foliage-removing machine with power-driven rotors and power-driven crop-scalping units with cutting discs. Rigid flails mounted on the forward rotor and flexible flails mounted on the rear rotos are separated with a transverse wall carrying a downwardly directed flexible shield. Vertically adjustable connectors mount the scalping units and ground-supporting wheels at the rear of the machine. The cutting discs are driven by the ground wheels.

U.S. Pat. No. 3,733,795 (Rabb et al., 1973) provides a beet topping and windrowing apparatus with a reduced turning radius that is achieved through the use of a plurality of follower wheels. The apparatus includes a pickup means having a plurality of rows of fingers, each finger being generally L-shaped in configuration, and a stripper means disposed vertically above and rearwardly of the pickup means for transferring items picked up by the pickup means to a conveyor. The stripper means has a rotatably mounted member with a plurality of longitudinally extending flaps disposed about the periphery. With this invention, the severed beet tops are laid flat on the ground and then picked back up by the fingers. This results in a lot of dirt in the windrow.

U.S. Pat. No. RE27695 (Barnes, 1973) discloses a beet topping assembly comprised of a series of beet topper units, each of which has a finder wheel and a topping knife. The invention further comprises a plurality of pivotal support members, the finder wheels and topping knives being suspended from the pivotal support members at equally spaced transverse intervals, and an overhead spring control mechanism mounted on a tractor.

U.S. Pat. No. 4,064,681 (Glifberg, 1977) shows a machine for the removal of foliage from root crops, including sugar beets. The machine includes a frame with a shaft that carries a stripping wheel. The stripping wheel is rotatably mounted in a forwardly open casing and has wings of propeller blade-like pitch for removing the foliage and carrying it away by means of an air stream generated by the wings. A vertically adjustable knife is attached to the machine frame behind the casing and severs the crowns of the sugar beets. The invention further comprises a cleaning and conveying wheel that is configured to clean the knife and carry away any plant residues that might otherwise obstruct the function of the knife.

U.S. Pat. No. 4,141,201 (Christensen, 1979) provides an apparatus for removing the tops of plants, such as onions, prior to their harvesting. The invention includes a floating frame secured to a fixed frame, the floating frame having rotating fingers for lifting the top and a rotating cutter blade for cutting the tops. The invention further comprises cleaning means for cleaning the rotating positioning fingers.

U.S. Pat. No. 5,660,034 (Gates et al., 1997) discloses a foldable root crop defoliator comprised of a central frame with lateral wings that are pivotally attached to the central frame. Plant top cutting and shredding devices are mounted to the wing frames and driven by a power train connected to the towing vehicle. The two lateral wings are independently adjustable relative to the ground. Each lateral wing may be rotated upward to a vertical position for transport or storage.

U.S. Patent Application Pub. No. 20180317382 (Richer et al) describes a beet head rimming apparatus for a beet-harvesting machine. The invention comprises a frame, two flail hubs rotatable about an axis, flails that are designed to remove leaves from beets remaining in the ground, and a drive configured to drive the flail hubs in relation to the frame. The flails are preferably blunt and have no cut edge. The beet head trimming apparatus is preferably a module that can be coupled to or decoupled from the beet-harvesting machine.

### BRIEF SUMMARY OF THE INVENTION

The present invention is a sugar beet defoliator and top saver comprising: a frame; a removable cover situated on top of the frame; a conveyor extending laterally from a first side of the frame to a second side of the frame; a plurality of steel flails disposed about a first rotating shaft, the first shaft being situated within the frame between a front end of the frame and the conveyor; a plurality of rubber flails disposed about a second rotating shaft, the second rotating shaft being situated within the frame rearward of the conveyor; two pairs of ground wheels situated outside of and rearward of the frame; a plurality of scalper blades arranged transversely relative to the frame and situated rearwardly of the two pairs of ground wheels; an interior shroud that is situated inside of the frame between the steel flails and a front end of the frame; and a crank arm that is configured to move a deflector plate from a first position to a second position; wherein the interior shroud is curved in shape and creates a space between an interior surface of the interior shroud and the plurality of steel flails, and wherein the space between the interior surface of the interior shroud and the plurality of steel flails increases from a bottom of the interior shroud to a top of the interior shroud; and wherein the deflector plate has a first end and a second end, wherein the first end of the deflector plate is hingedly attached to the frame, wherein when the deflector plate is in the first position, it extends horizontally parallel with a top end of the interior shroud, and when the deflector plate is in the second position, it is situated between the plurality of steel flails and the conveyor.

In a preferred embodiment, the present invention further comprises a first mud flap situated between the conveyor and the plurality of rubber flails. In another preferred embodiment, the present invention further comprises a second mud flap extending downwardly from a top part of the frame between the plurality of rubber flails and the two pairs of ground wheels.

In a preferred embodiment, the first rotating shaft is configured to be driven by a power takeoff situated on a rear end of a tractor, and the invention further comprises a draw bar situated at a front end of the frame and configured for attachment to the rear end of the tractor. Preferably, the present invention further comprises a turnbuckle that is configured to adjust a height of the frame relative to a ground.

In a preferred embodiment, the present invention further comprises a first hydraulic motor that is configured to adjust a height of the plurality of scalper blades, a second hydraulic motor that is configured to operate a steering system that is mechanically coupled to the two pairs of ground wheels, a third hydraulic motor that is configured to drive the second rotating shaft, and a fourth hydraulic motor that is configured to operate the conveyor.

In a preferred embodiment, the frame comprises two opposing side walls, the frame has a width that is defined by the distance between the two opposing side walls, the conveyor has a width that is defined by the length of the conveyor, and the width of the conveyor is greater than the width of the frame so that the conveyor extends beyond the side walls of the frame on either side of the frame.

### BRIEF DESCRIPTION OF THE DRAWINGS

FIG. 1 is a front perspective view of the present invention shown attached to a tractor.

FIG. 2 is a rear perspective view of the present invention shown attached to a tractor.

FIG. 3 is a side view of the present invention shown attached to a tractor.

FIG. 4 is a detail perspective view of the attachment points between the present invention and the tractor.

FIG. 5 is a top view of the present invention shown with the cover closed.

FIG. 6 is a side view of the present invention shown with the cover closed.

FIG. 7 is a first front perspective view of the present invention.

FIG. 8 is a second front perspective view of the present invention.

FIG. 9 is a detail perspective view of the chain and sprocket of the present invention.

FIG. 10 is a detail perspective view of the steering apparatus of the present invention.

FIG. 11 is a detail perspective view of the rear scalper blades of the present invention.

FIG. 12 is a detail perspective view of the steel flails shown from underneath the conveyor mechanism.

FIG. 13 is detail perspective view of the interior shroud of the present invention.

FIG. 14 is a side view of the steel flails relative to the shroud.

FIG. 15 is a side perspective view of the present invention shown with the cover open.

FIG. 16 is a top perspective view of the shroud shown with the cover open.

FIG. 17 is a detail perspective view of the rubber flails.

FIG. 18 is a side perspective view of the present invention shown with the crank arm attached.

FIG. 19 is a detail perspective view of the crank arm.

FIG. 20 is a detail perspective view of the conveyor shown with the crank arm in an up position.

FIG. 21 is a top perspective view of the deflector plate shown with the crank arm in an up position.

FIG. 22 is a rear perspective view of the present invention shown with the scalper blades in a down position.

FIG. 23 is a perspective view of the invention illustrating an alterative method of driving the second rotating shaft.

### REFERENCE NUMBERS

1 Frame
1a Front end (of frame)
1b Rear end (of frame)
2 Cover
3 Conveyor
4 First rotating shaft
5 Steel flails
6 Rubber flails
7 Second rotating shaft
8 Ground wheels
9 Scalper blades
10 First drive wheel
11 Second drive wheel
12 Belt
13 Third drive wheel
14 Turnbuckle
15 Draw bar
16 Hammer strap
17 Hitch pin
18 Power takeoff
19 Drive shaft
20 Gear box
21 Drive shaft
22 Hydraulic hose connection box
22a First stack (of hydraulic hoses)
22b Second stack (of hydraulic hoses)
22c Third stack (of hydraulic hoses)
22d Fourth stack (of hydraulic hoses)
23 Hydraulic motor (scalper blades)
24 Hydraulic motor (rubber flails)
25 Hydraulic motor (conveyor)
26 First mud flap
27 Second mud flap
28 Front bracket
29 Pivot point
30 Chain
31 Large sprocket
32 Conveyor frame
33 Small sprocket
34 Rod
35 Upright bracket
36 Pivot point
37 Connecting member
38 Tie rod
39 Hydraulic cylinder
40 Arm
41 Tube
42 Plate
43 Brace
44 Collar
45 Support Bracket
46 Shroud
47 First drum
48 Longitudinal support bar
49 Deflector plate
50 Crank arm
51 Hinge
52 Second drum
53 Deflector plate shaft
54 Pin
55 Bracket
56 Side wall (of frame)
57 Deflector plate frame
58 Collar
59 Spring
60 Rod
61 Bushing
62 Chain

### DETAILED DESCRIPTION OF INVENTION

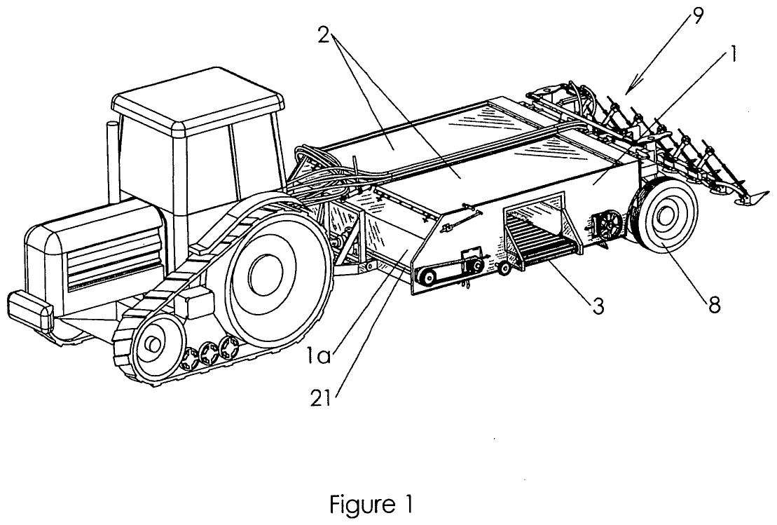

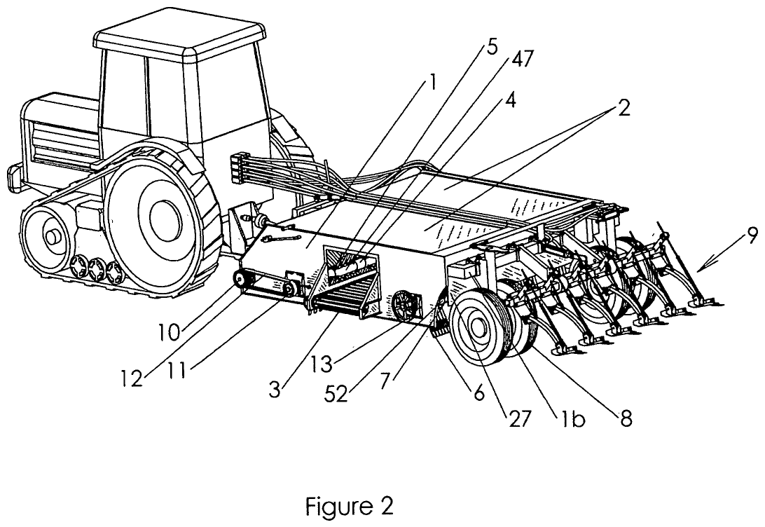

FIG. 1 is a front perspective view of the present invention shown attached to a tractor. As shown in this figure, the invention comprises a frame 1, a cover 2, and a conveyor 3 that extends laterally from one side of the frame to the other. Situated inside of the frame between the front end of the frame 1a and the conveyor 3 is a plurality of steel flails 4 disposed about a first drum (not shown) on a first rotating shaft 5 (see FIG. 2). Situated inside of the frame between the conveyor 3 and the mud flap 1b is a plurality of rubber flails 6 disposed about a second drum (not shown) on a second rotating shaft 7 (see FIG. 2). The invention further comprises two pairs of ground wheels 8 situated outside of and to the rear of the frame 1 and a plurality of scalper blades 9 arranged transversely relative to the frame 1 and disposed rearwardly of the ground wheels 8.

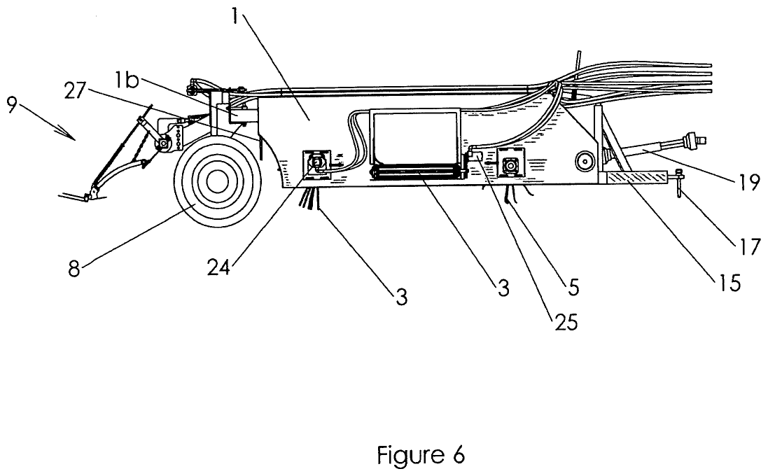

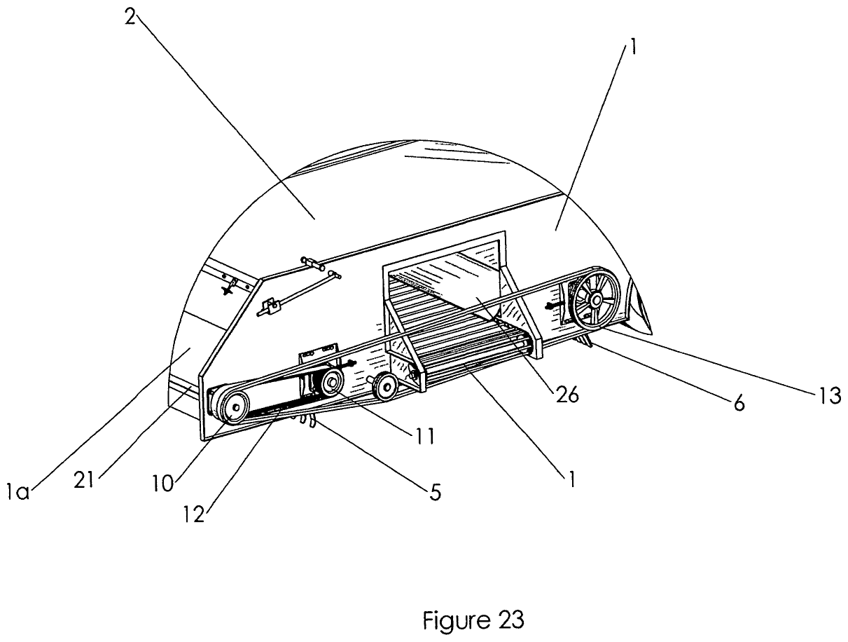

FIG. 2 is a rear perspective view of the present invention shown attached to a tractor. During operation, the cover 2 would be in a closed position, as shown. This figure shows the first and second drive wheels 10, 11 and the belt 12 that surrounds them. These drive wheels 10, 11 and belt 12 operate the first rotating shaft 4. The second rotating shaft 7 is preferably operated by a separate hydraulic motor (see FIG. 6), but it may also be operated via an optional third wheel 13. To use this drive wheel, a belt would be placed around the third drive wheel 13 and also around the first drive wheel 10 so that the first and second rotating shafts would both be driven by the power takeoff 18 (see FIG. 23). When this method is used, one side of the conveyor 3 is impeded.

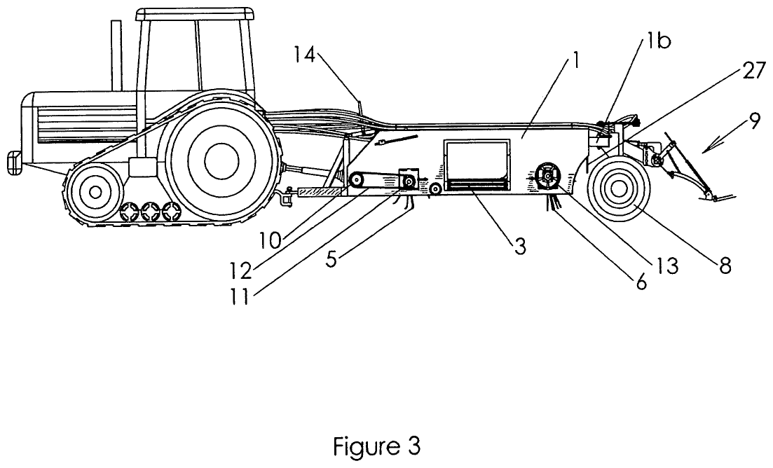

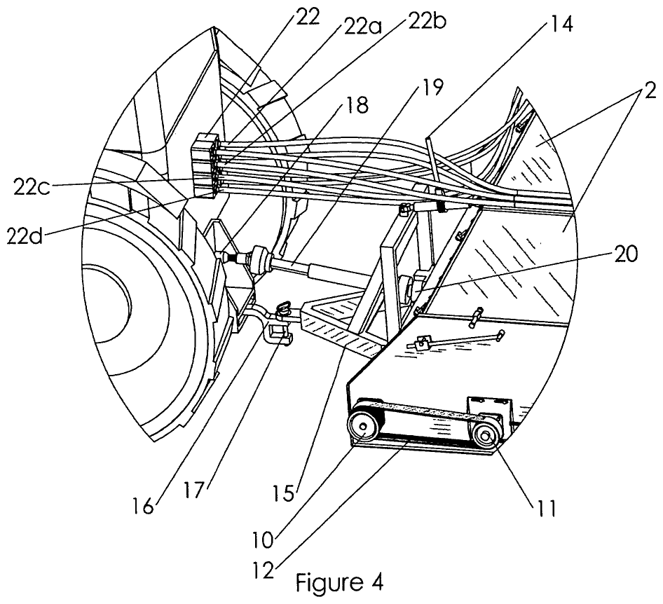

FIG. 3 is a side view of the present invention shown attached to a tractor. As shown in this figure, the steels flails 5 and rubber flails 6 both extend beneath the bottom edge of the frame 1. The height of the steel flails 5 and of the rubber flails 6 relative to the ground can be adjusted via a turnbuckle 14 that raises and lowers the entire machine. The steel flails 5 are preferably situated so that they extend just above the crown of the beets. The rubber flails 6 are preferably longer than the steel flails 5 and so that they contact the crown of the beet in the dirt. The height of the scalper blades 9 relative to the ground is adjusted via a separate hydraulic motor 23. (Once positioned, the tension of the scalper blades 9 relative to the ground is maintained by a spring 59 situated around a rod 60 that fits telescopically inside of a bushing 61. The chain 62 acts as a limiting strap so that the rod does not fall out of the bushing 61.) This figure also clearly illustrates that there are three points at which the invention is attached to the tractor. These three attachment points are discussed in detail in connection with FIG. 4.

FIG. 4 is a detail perspective view of the attachment points between the present invention and the tractor. The first attachment point is between the draw bar 15 extending from the front of the frame 1 and the hammer strap 16 on the rear of the tractor; these two parts are joined together by a hitch pin 17. The second attachment point is at the power takeoff 18 at the rear of the tractor. A longitudinally oriented drive shaft 19 extends rearwardly from the power takeoff 18 and transfers power to a gear box 20 situated at the front end 1a of the frame. The gears inside of the gear box 20 are configured to drive a transversely oriented drive shaft 21, which is also situated just outside of the front end 1a of the frame. Note that in FIG. 4, the draw bar 15 has not been inserted into the hammer strap 16, but in a preferred embodiment, the hammer strap 16 would be flipped (so that the “C” part of the hammer strap is on the top rather than on the bottom), and the front part of the draw bar 15 would be inserted into the hammer strap 16 and secured with the hitch pin 17.

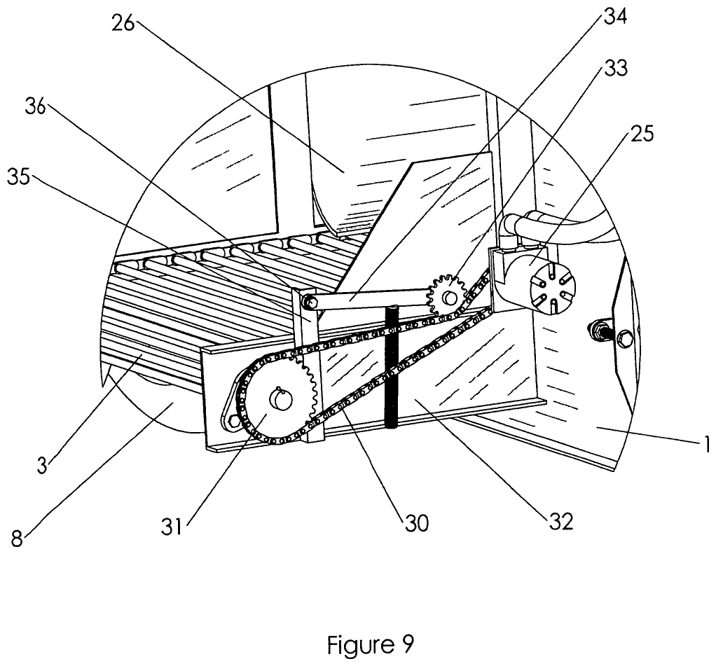

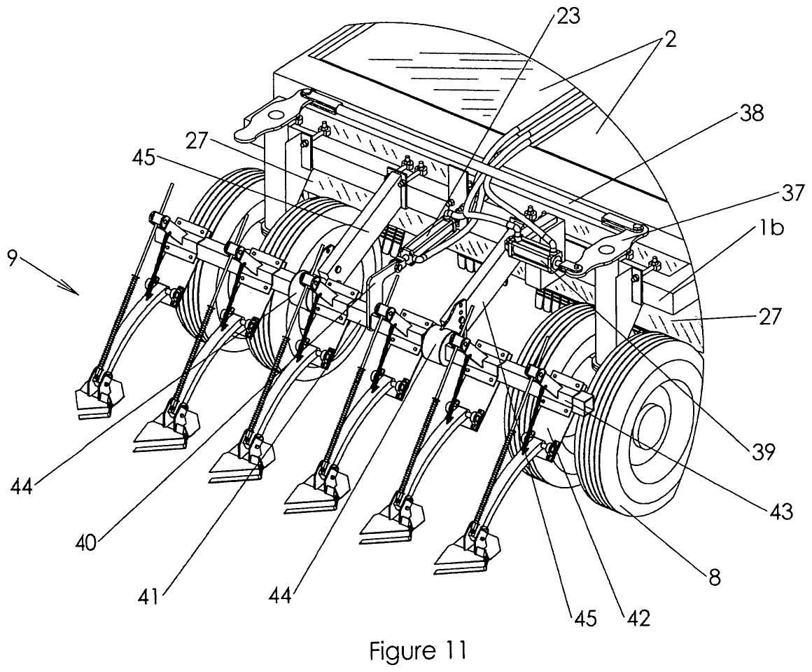

The third attachment point between the invention and the tractor is at the hydraulic hose connection box 22. As shown in this figure, the invention comprises four sets (or stacks) of hydraulic hoses. Each stack is operated via a separate control in the cab of the tractor. The upper-most pair (first stack) of hydraulic hoses 22a control the hydraulic cylinder 23 that raises and lowers the scalper blades 9. The second stack of hydraulic hoses 22b controls the hydraulic cylinder 39 that operates the steering system (see FIG. 11). The third stack of hydraulic hoses 22c control the hydraulic motor 24 that drives the second rotating shaft 7/rubber flails 6 (see FIG. 6). The hydraulic motor 24 can be run forward or backward, thereby changing the direction of rotation of the rubber flails 6 without having to change the direction of travel of the tractor. The fourth (or lowest) stack of hydraulic hoses 22d control the hydraulic motor 25 that runs the conveyor 3 (see FIG. 9).

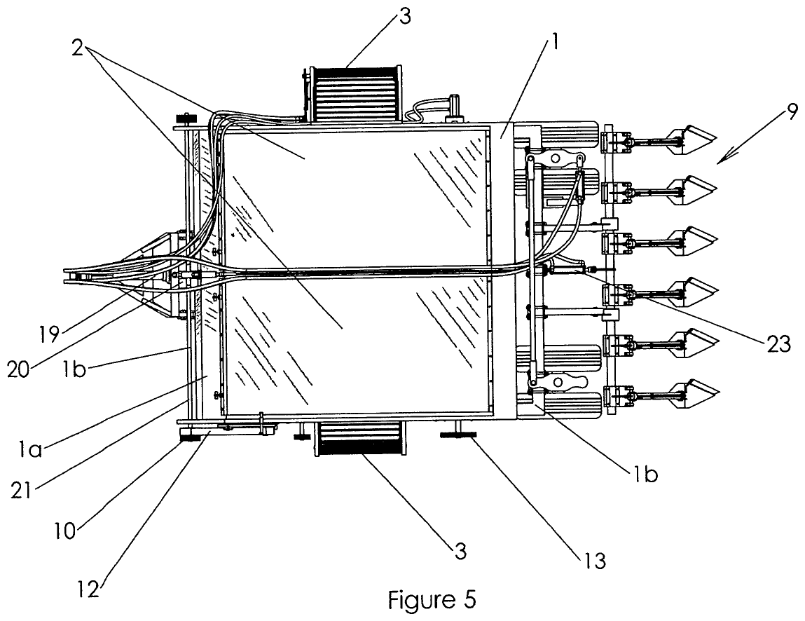

FIG. 5 is a top view of the present invention shown with the cover closed. This figure clearly shows the two pairs of ground wheels 8 situated between the rear end of the frame 1 the scalper blades 9. It also shows the various hydraulic hose connections discussed above. Note that the conveyor 3 extends beyond the width of the frame 1 by a certain distance on either side of the frame. This is to permit the saved sugar beet tops to be disposed on either side of the invention, the conveyor being able to run in either direction per the hydraulic motor control.

FIG. 6 is a side view of the present invention shown with the cover closed. This figure shows the invention without the tractor from the opposite side as shown in FIG. 3. In this figure, the scalper blades 9 are in a raised position, which means that they do not come into contact with the ground.

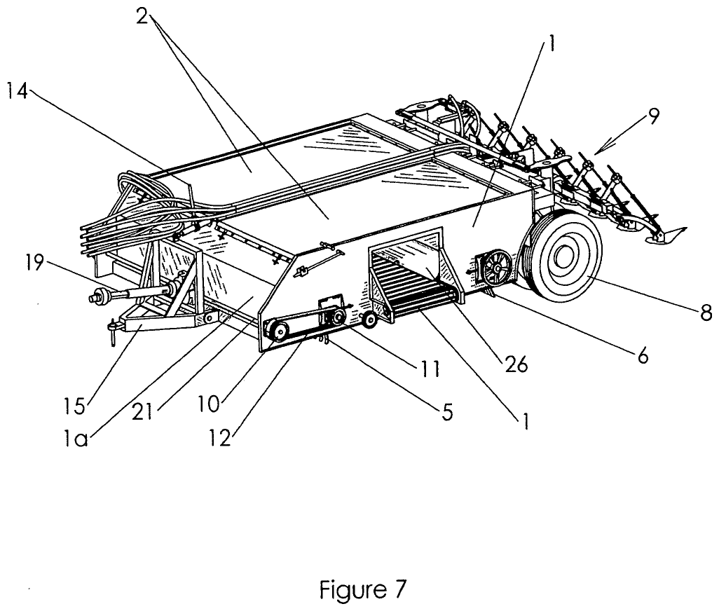

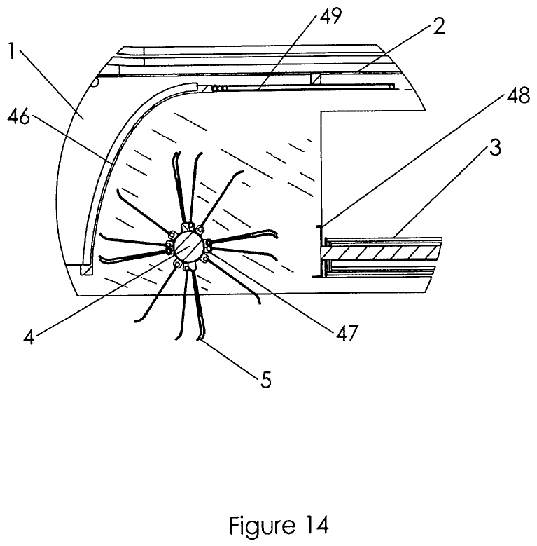

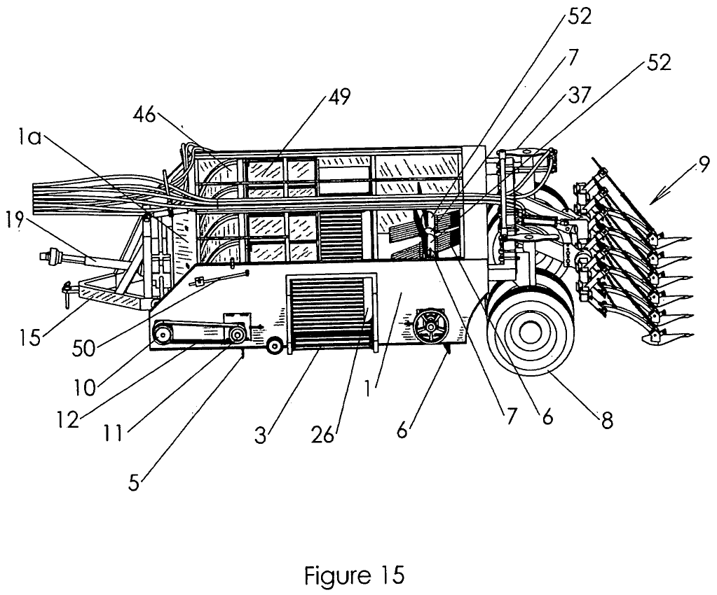

FIG. 7 is a first front perspective view of the present invention. This figure shows the first mud flap 26 extending from the top part of the frame down to the conveyor 3. The purpose of this mud flap 26 is to prevent dirt and debris from hitting the rubber flails 6 and the second drum 52 on the second rotating shaft 7 (see also FIGS. 14 and 15). Instead, dirt and debris is kicked back onto the conveyor 3 and deposited with the beet tops into windrows on either side of the machine. The invention further comprises a second mud flap 27 extending downwardly from the top part of the frame between the rubber flails 6 and the ground wheels 8 (see FIG. 11).

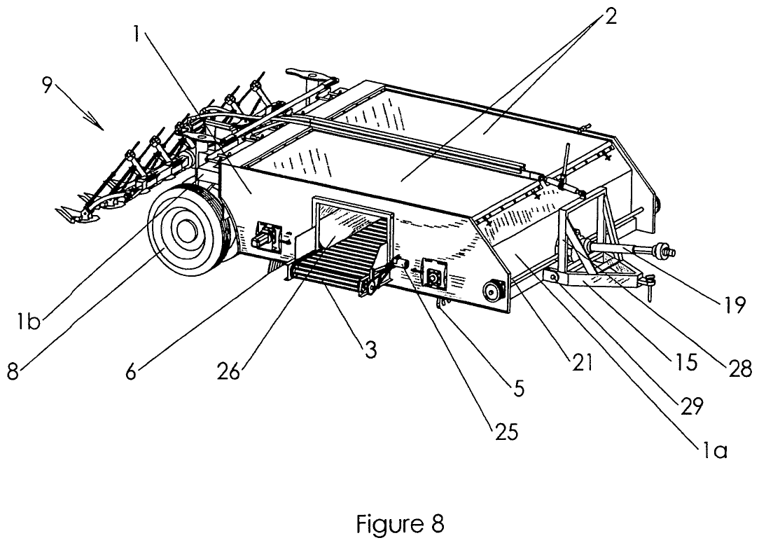

FIG. 8 is a second front perspective view of the present invention. The hydraulic hoses have been omitted from this figure for clarity. This figure clearly shows the turnbuckle 14, which is connected to a front bracket 27. The lower ends of the front bracket 27 are connected to the draw bar 15 at pivot points 29. The turnbuckle can be used to raise or lower the height of the front end of the machine, thereby adjusting the level of the steel flails 5 relative to the ground.

FIG. 9 is a detail perspective view of the chain and sprocket of the present invention. Chain 30 is engaged with a large sprocket 31 situated on the front side of the conveyor frame 32, a small sprocket 33 situated on the end of a rod 34 that is pivotally attached to an upright bracket 35 on the front side of the frame 32 at pivot point 36, and a third sprocket (not shown) that is driven by the hydraulic motor 25. Tension on the chain 30 can be adjusted by adjusting the angle of the small sprocket 33 via pivot point 36.

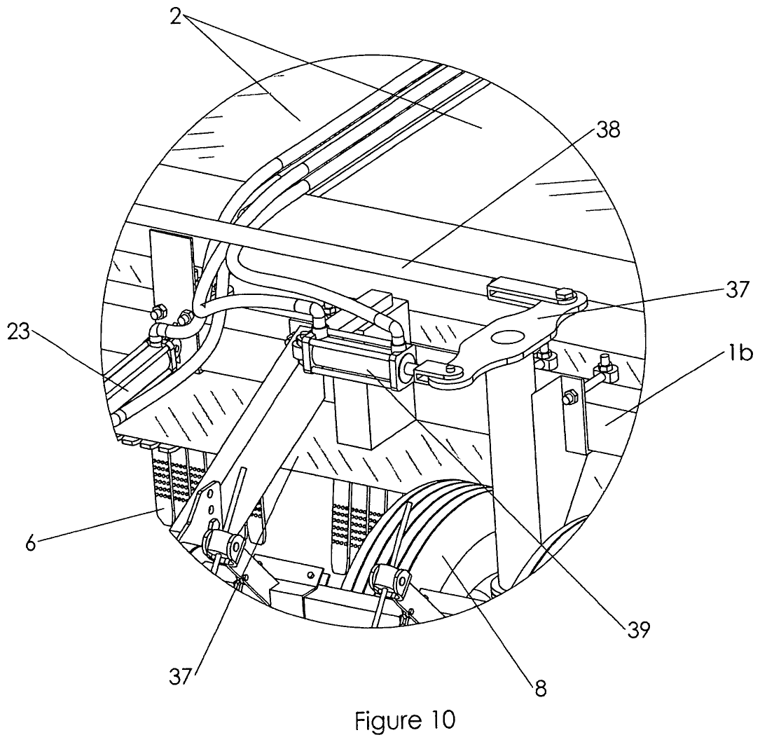

FIG. 10 is a detail perspective view of the steering apparatus of the present invention. As shown in this figure, each pair of ground wheels 8 is connected to a connecting member 37, which is pivotally attached to a tie rod 38 that extends laterally across the rear of the machine. One of the connecting members 37 is also pivotally attached to a hydraulic cylinder 39. In this manner, the direction of the ground wheels 8 changes as the hydraulic cylinder 39 is extended and retracted.

FIG. 11 is a detail perspective view of the rear scalper blades of the present invention. As noted above, the height of the scalper blades 9 relative to the ground can be adjusted via the hydraulic cylinder 23. In this figure, the hydraulic cylinder 23 is retracted, and the scalper blades 9 are in a raised position. The hydraulic cylinder 23 is pivotally attached to an arm 40, which is also attached to a tube 41 extending laterally across the width of the machine. Each scalper blade 9 is coupled to the tube 41 via a plate 42 and brace 43. The tube 41 is configured to rotate within collars 44 that are connected to support brackets 45 extending diagonally from the frame 1.

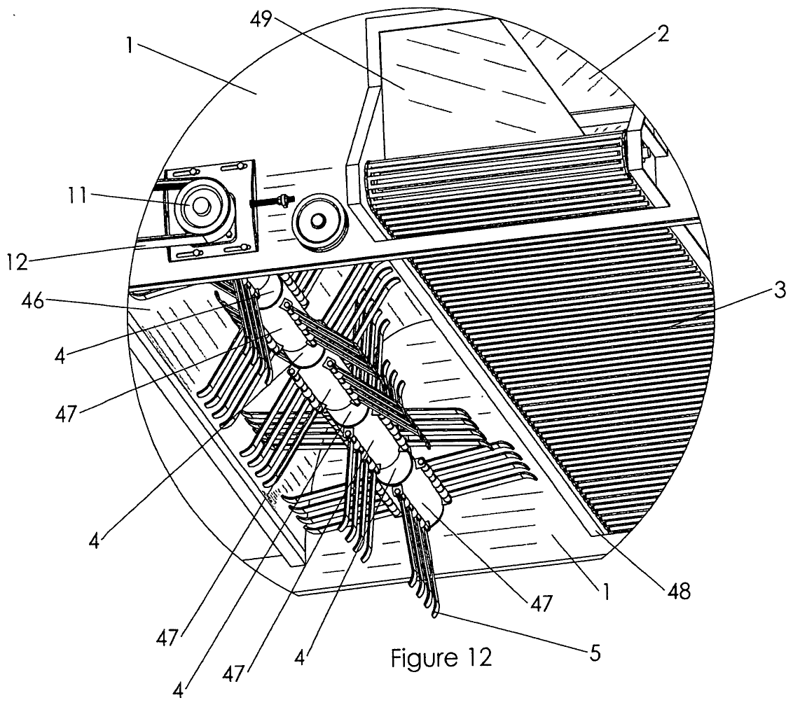

FIG. 12 is a detail perspective view of the steel flails shown from underneath the conveyor mechanism. This figure shows the conveyor 3, which is horizontal relative to the ground. It also shows the steel flails 5 situated underneath the shroud 46, which is discussed more fully below. The steel flails 5 are arranged radially about a first drum 47 that encircles the first rotating shaft 4 and is configured to rotate with the first rotating shaft 4. The steel flails 5 are preferably arranged in groups, with spaces between the groups, on the first drum 47 so as to create gaps between the groups of steel flails 5.

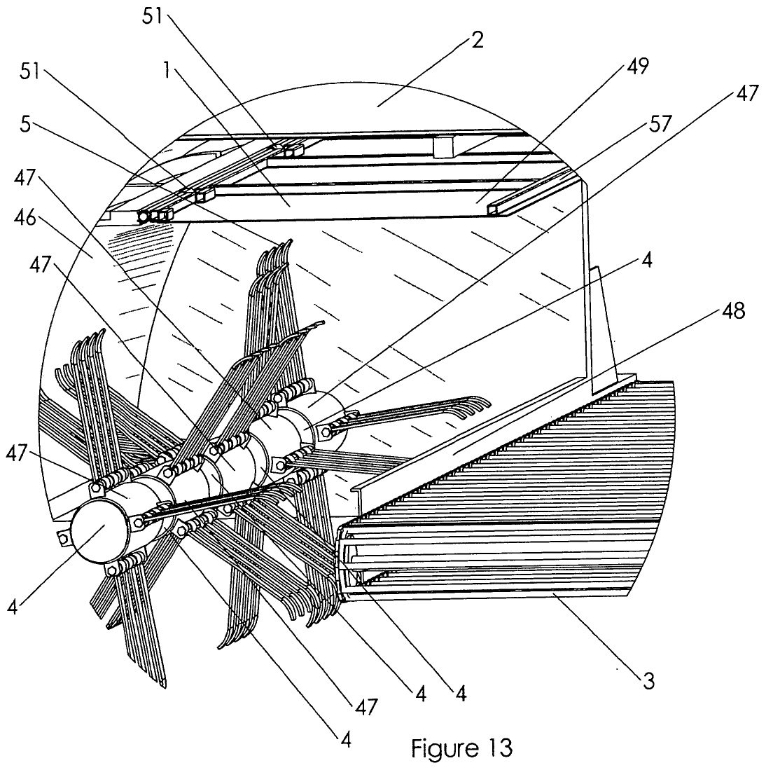

FIG. 13 is detail perspective view of the interior shroud of the present invention. In this figure, the side wall 56 of the frame 1 has been removed for clarity. In a preferred embodiment, each group of steel flails 5 comprises four flails. This figure clearly shows the gap between each group of flails. A longitudinal support bar 48 extends laterally along the length of the conveyor 3 between the steel flails 5 and the conveyor 3.

FIG. 14 is a side view of the steel flails relative to the shroud. As shown in this figure, the shroud 46 is configured (sized and shaped) so that the distance between the tips of the steel flails 5 and the inside surface of the shroud increases from the bottom of the shroud to the top of the shroud. In other words, the angle at which the shroud is curved increases (opens up) from the bottom of the shroud to the top (or ceiling) of the shroud. At the bottom of the shroud, the tips of the steel flails are relatively close to the inside surface of the shroud, but at the top (ceiling) of the shroud, the gap between the tips of the flails and the inside surface of the shroud has increased, thereby creating a cavity into which the beet tops are thrown by the flails and through which they are transported onto the conveyor 3.

FIG. 15 is a side perspective view of the present invention shown with the cover open. This figure shows the top of the shroud 46, as well as the deflector plate 49, which will be discussed more fully below. It also shows the crank arm 50, which is in a down (or stowed) position in this figure. With the crank arm in this position, the deflector plate is in an up position, as shown. In this position, the beet tops that are dislodged by the steel flails are transported onto the conveyor 3.

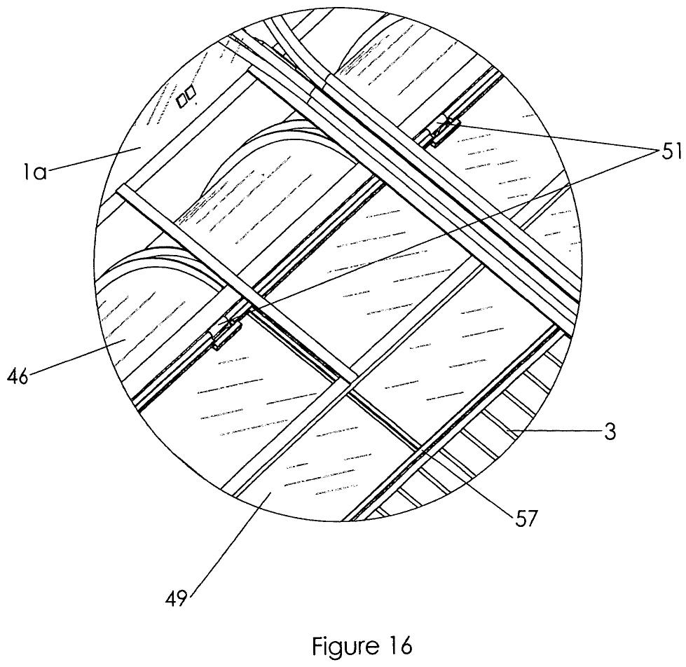

FIG. 16 is a top perspective view of the shroud shown with the cover open. This figure shows the shroud 46 underneath the frame 1 and the deflector plate 49. The deflector plate is hingedly attached to the frame at hinges 51. Note that the top end of the shroud 46 tucks up underneath the deflector plate 49 (see FIG. 13).

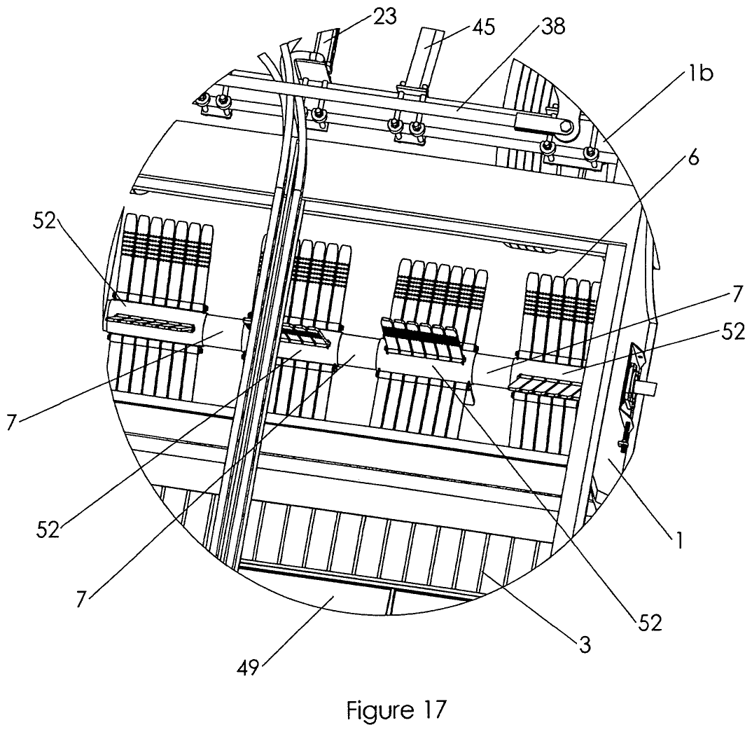

FIG. 17 is a detail perspective view of the rubber flails. As shown in this figure, the rubber flails 6 are arranged radially around a second drum 52 that is fixedly attached to the second rotating shaft 7. In a preferred embodiment, the rubber flails are grouped together, with spaces between the separate groups of flails, to create gaps between them. In a preferred embodiment, each group comprises six rubber flails 6.

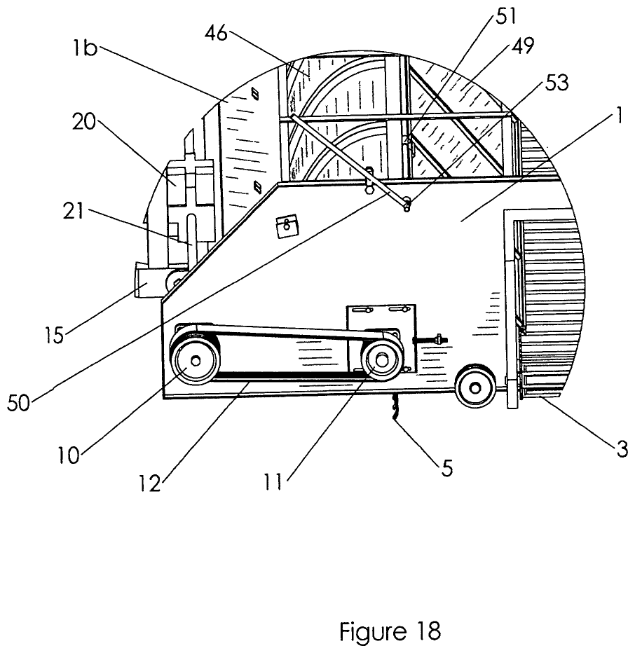

FIG. 18 is a side perspective view of the present invention shown with the crank arm attached. In this figure, the crank arm 50 has been rotated from its stowed position (shown in FIG. 15) to the up position shown here. The crank arm 50 is fixedly attached to a deflector plate shaft 53 so that when the crank arm 50 is rotated upward, the deflector plate 49 is rotated downward.

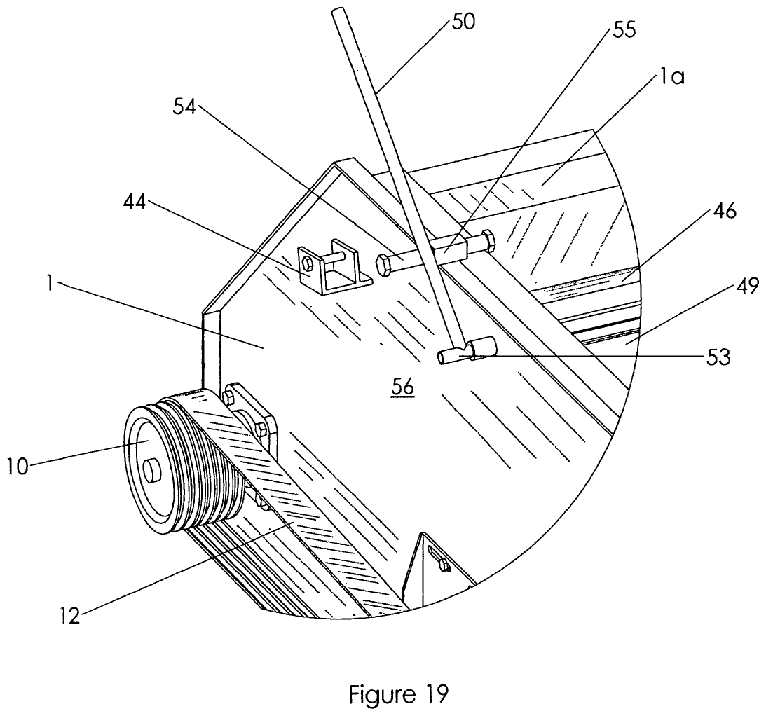

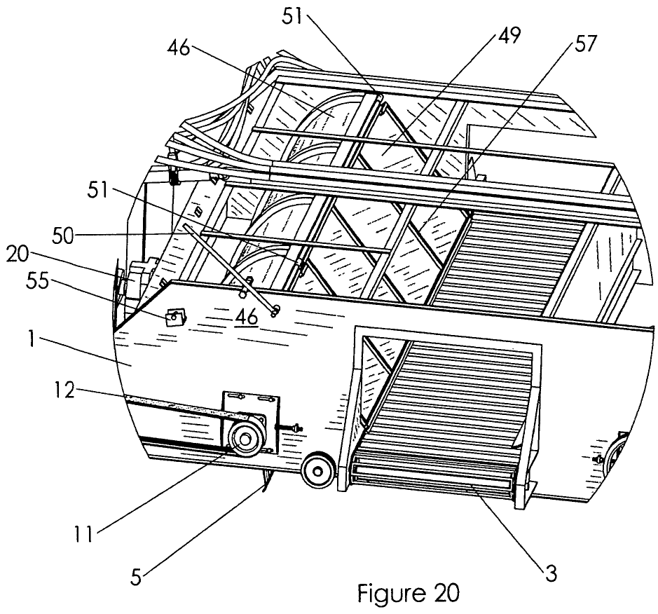

FIG. 19 is a detail perspective view of the crank arm. As shown in this figure, the crank arm 50 is supported in its upward position by a pin 54 that extends through a bracket 55 attached to the frame 1. One end of the crank arm 50 is attached to the deflector plate shaft 53, which passes through the side wall 56 of the frame. On the inside of the side wall 56, the deflector plate shaft 53 is attached (welded) to the deflector plate frame 57. In this manner, as the deflector plate shaft 53 is rotated by the crank arm 50, the deflector plate rotates upwardly or downwardly. The pin 54 is situated so that when the crank arm 50 rests on the pin 54, the deflector plate 49 is in a completely down position, thereby preventing the beet tops from being disposed onto the conveyor 3 (see FIG. 20). Instead, the beet tops are thrown back onto the ground in between the groups of steel flails 5.

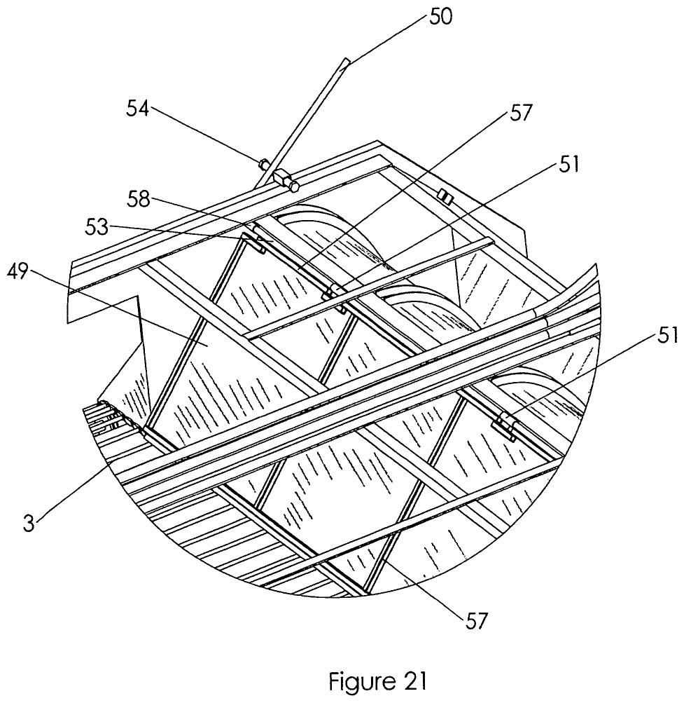

FIG. 21 is a top perspective view of the deflector plate shown with the crank arm in an up position. This figure clearly shows the deflector plate shaft 53, which rotates within collars 58 that are welded to the frame 1. Note that the bottom edge of the deflector plate 49 rests against the longitudinal support bar 48.

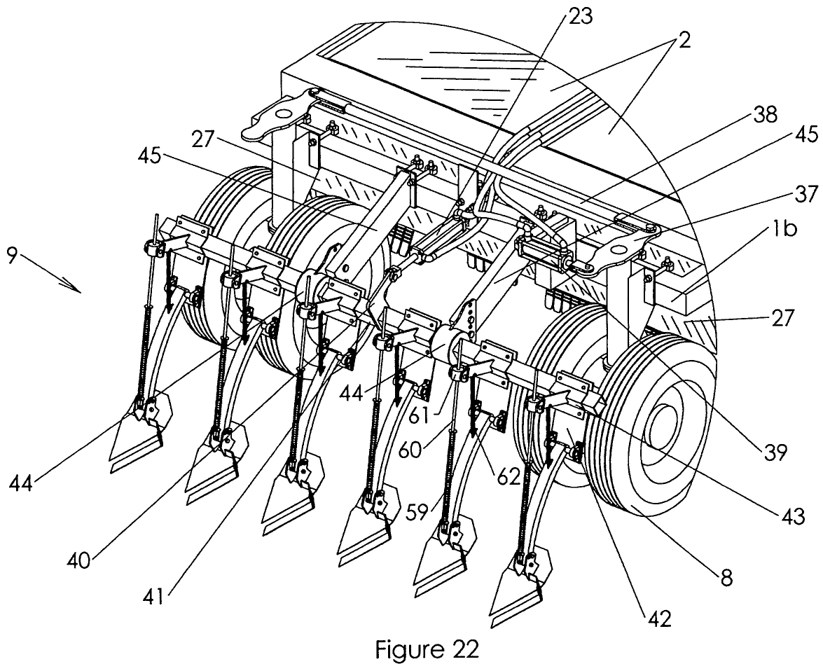

FIG. 22 is a rear perspective view of the present invention shown with the scalper blades in a down position. In this figure, the hydraulic cylinder 23 has been extended, thereby causing the scalper blades 9 to move into a lowered position.

Now that the structure of the invention has been described in detail, we will turn to the operation of the machine. As the tractor moves forward, with all hydraulic motors activated and the deflector plate in an up position, the steel flails 5 remove the tops from the sugar beets, throwing them onto the conveyor 3, which deposits the beet tops to the right or left of the machine. The steel flails 5 remove approximately ninety percent (90%) of the beet tops, and the rubber flails 58 remove the remaining ten percent (10%). It is a significant advantage of the present invention that the beet tops are not removed, dropped onto the ground, and then picked up again (as with a conventional top saver machine). Instead, the beet tops are removed and deposited on either side of the machine without ever touching the ground in between (i.e., they are cut and deposited—not cut, deposited, picked up again, and deposited again). This results in less dirt and debris being included with the beet tops, which are typically used as livestock feed.

With the deflector in a lowered position, the beet tops are cut by the steel flails and deposited into rows corresponding to the gaps between the groups of steel flails. Note that the conveyor would be turned off if the deflector plate is down. The scalper blades remove the crowns of the beets. Thus, the present invention performs three functions—the removal of beet tops by the steel flails, defoliation by the rubber flails, and de-crowning of the beets by the scalper blades. No other machine in existence today performs all three of these functions at the same time. Furthermore, the present invention allows the operator to deposit the beet tops in windrows to either side of the machine or to leave them on the ground underneath the machine, where they are pulverized further by the rubber flails.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A sugar beet defoliator and top saver comprising:
(a) a frame;
(b) a removable cover situated on top of the frame;
(c) a conveyor extending laterally from a first side of the frame to a second side of the frame;
(d) a plurality of steel flails disposed about a first rotating shaft, the first shaft being situated within the frame between a front end of the frame and the conveyor;
(e) a plurality of rubber flails disposed about a second rotating shaft, the second rotating shaft being situated within the frame rearward of the conveyor;
(f) two pairs of ground wheels situated outside of and rearward of the frame;
(g) a plurality of scalper blades arranged transversely relative to the frame and situated rearwardly of the two pairs of ground wheels;
(h) an interior shroud that is situated inside of the frame between the steel flails and a front end of the frame; and
(i) a crank arm that is configured to move a deflector plate from a first position to a second position;
wherein the interior shroud is curved in shape and creates a space between an interior surface of the interior shroud and the plurality of steel flails, and wherein the space between the interior surface of the interior shroud and the plurality of steel flails increases from a bottom of the interior shroud to a top of the interior shroud; and
wherein the deflector plate has a first end and a second end, wherein the first end of the deflector plate is hingedly attached to the frame, wherein when the deflector plate is in the first position, it extends horizontally parallel with a top end of the interior shroud, and when the deflector plate is in the second position, it is situated between the plurality of steel flails and the conveyor.

2. The sugar beet defoliator and top saver of claim 1, further comprising a first mud flap situated between the conveyor and the plurality of rubber flails.

3. The sugar beet defoliator and top saver of claim 2, further comprising a second mud flap extending downwardly from a top part of the frame between the plurality of rubber flails and the two pairs of ground wheels.

4. The sugar beet defoliator and top saver of claim 1, wherein the first rotating shaft is configured to be driven by a power takeoff situated on a rear end of a tractor, the invention further comprising a draw bar situated at a front end of the frame and configured for attachment to the rear end of the tractor.

5. The sugar beet defoliator and top saver of claim 1, further comprising a turnbuckle that is configured to adjust a height of the frame relative to a ground.

6. The sugar beet defoliator and top saver of claim 1, further comprising a first hydraulic motor that is configured to adjust a height of the plurality of scalper blades.

7. The sugar beet defoliator and top saver of claim 6, further comprising a second hydraulic motor that is configured to operate a steering system that is mechanically coupled to the two pairs of ground wheels.

8. The sugar beet defoliator and top saver of claim 7, further comprising a third hydraulic motor that is configured to drive the second rotating shaft.

9. The sugar beet defoliator and top saver of claim 8, further comprising a fourth hydraulic motor that is configured to operate the conveyor.

10. The sugar beet defoliator and top saver of claim 1, wherein the frame comprises two opposing side walls, wherein the frame has a width that is defined by the distance between the two opposing side walls, wherein the conveyor has a width that is defined by the length of the conveyor, and wherein the width of the conveyor is greater than the width of the frame so that the conveyor extends beyond the side walls of the frame on either side of the frame.
